(19) United States
(12) Patent Application Publication
(10) Pub. No.: US 2008/0111384 A1
(43) Pub. Date: May 15, 2008

(54) SPRING RETAINER

(76) Inventor: PHILIP C. ELLIS, Sinking Spring, PA (US)

Correspondence Address: Richard J. Veltman, Esq.;The Black & Decker Corporation, 701 East Joppa Road TW199, Towson, MD, 21286, US

(21) Appl. No.: 11/940,510

(22) Filed: Nov. 15, 2007

Related U.S. Application Data
(60) Provisional application No. 60/865,900, filed on Nov. 15, 2006.

(51) Int. Cl. E05B 3/00

(52) U.S. Cl. 292/336.3

(57) ABSTRACT

A spring retainer includes an annular ring portion and an arm extending outwardly from the ring portion. Two diametrically opposed lugs extend radially inwardly from the ring portion.

The present application is a Continuation-In-Part of co-pending Provisional Application Ser. No. 60/865,900, filed Nov. 15, 2006.

The present invention relates to door hardware. In particular, the invention relates to methods and apparatus for retaining a spring in a shank portion of a door knob or lever and retaining a spindle in the broach of the shank portion.

### BRIEF DESCRIPTION OF THE DRAWINGS

FIG. 1 is an exploded view of a portion of a lever set.

FIG. 2 illustrates an assembled lever set.

FIG. 3 is a section view taken through FIG. 2.

FIG. 4 is an exploded view of a portion of a lever set.

FIGS. 5-9 illustrates an assembly sequence for a lever set.

### DETAILED DESCRIPTION OF THE DRAWINGS

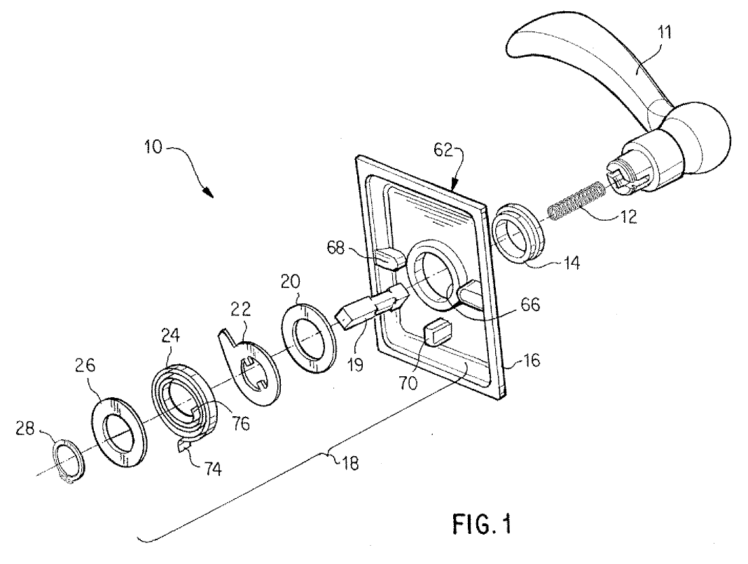

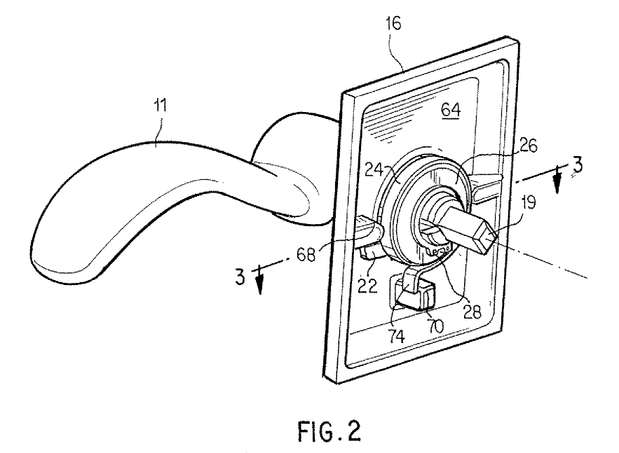

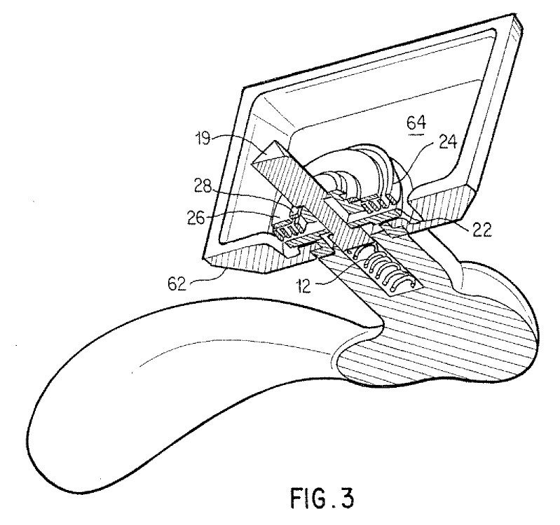

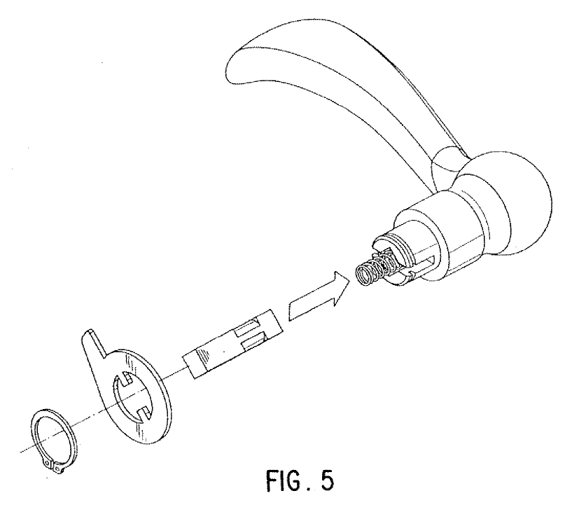

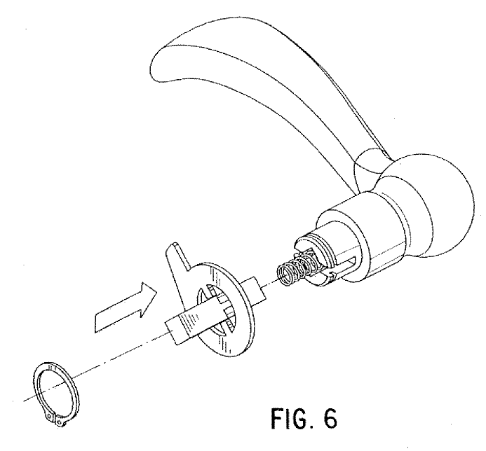

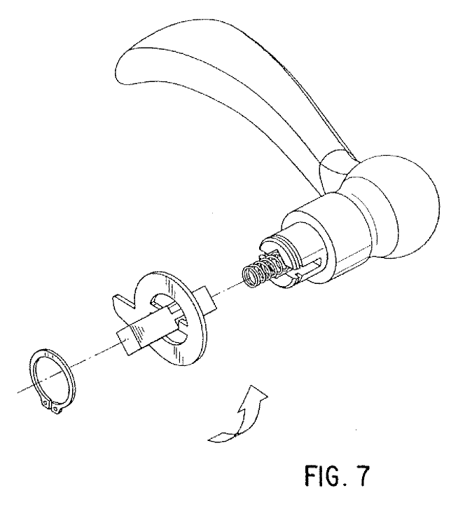

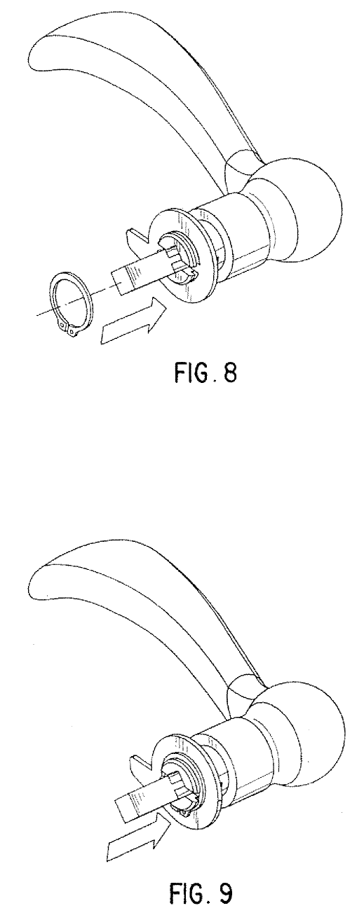

The present invention is illustrated in FIGS. 1-9. Although illustrated with reference to a door lever, it is equally applicable to a door knob.

FIG. 1 illustrates an exploded view of a lever assembly 10. The components include a lever 11, biasing spring 12, bushing 14, escutcheon 16, spindle assembly 18, inner washer 20, and retaining ring 28. The spindle assembly 18 includes spindle 19, spring retainer 22, torsion spring 24, and outer washer 26.

The lever 10 includes a shank 32 defining a broach 34 for receiving the spindle 19, a circumferential groove 42 formed at its distal end for receiving the retaining ring 28, and a slot 44. The slot 44 is formed along a diameter of the shank 32.

The spindle 19 includes first and second square portions 46, 48 and an intermediate portion 52 disposed between the first and second square portions 46, 48. The intermediate portion 52 cooperates with the first and second square portions 46, 48 to form a first stop surface 53 and a second stop surface 55. The first end portion 46 is sized and configured to provide a close fit when the spindle 19 is inserted into the broach 34. In the illustrated embodiment, the first and second end portions 46, 48 have square cross sections, and the intermediate portion 52 has an octagonal cross-section, although a circular cross-section would also work for the intermediate portion 52.

The spring retainer 22 includes an annular ring portion 54 and an arm 56 extending outwardly from the ring portion 54. Two diametrically opposed lugs 58 extend radially inwardly from the ring potion 54. The ends of the lugs 58 are separated by a distance slightly greater than the width of the spindle 19, and the width of the lugs 58 is slightly less than the width of the slot 44.

The escutcheon 16 includes a decorative outer surface 62 and an inner surface 64, with an aperture 66 extending through the escutcheon 16 for receiving the shank 32 and bushing 14. The inner surface 64 includes bosses 68, 70. Boss 68 is positioned to engage the arm 56 of the spring retainer 22 and boss 70 is positioned to engage a first end 74 of the torsion spring 24. A second end 76 of the torsion spring 24 is configured to engage the slot 44.

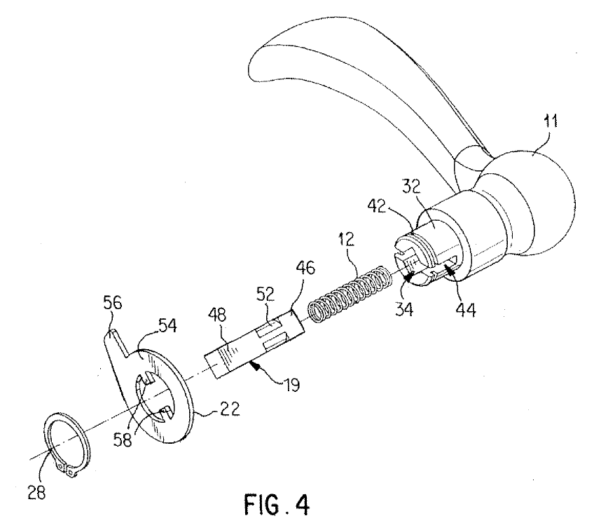

FIGS. 4-9 illustrate how the spring retainer 22 is installed on the spindle 19. The spring retainer 22 is mounted on the spindle 19 by passing the spindle 19 between the lugs 58 until the lugs 58 are positioned at the undercut octagonal portion 52. The spring retainer 22 is then rotated 45°, positioning them between the first and second stop surfaces 53, 55. Once rotated, the stop surfaces 53, 55 restrict the longitudinal movement of the spring retainer 22 to the length of the intermediate portion 52.

With the spring retainer 22 installed on the spindle 19, the spindle assembly 18 is completed by mounting the torsion spring 24 on the spindle 19 adjacent the spring retainer 22, followed by the outer washer 26.

The lever assembly 10 can be assembled by mounting the bushing 14 on the shank 32 and inserting the shank 32 into the aperture 66. The biasing spring 12 is inserted into the broach 34, and the inner washer 20 is mounted on the shank 32. The spindle assembly 18 is then inserted into the shank 32, aligning the lugs 58 with the slot 44, such that the arm 56 engages boss 68, and positioning the first end 74 of the torsion spring 24 against boss 70 and the second end 76 in the slot 44. The retaining ring 28 is installed in the circumferential groove 42 of the shank 32.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A door knob or lever assembly comprising:
an escutcheon having an aperture, an inner surface and first and second bosses extending from the inner surface;
a knob or lever having a shank extending through the aperture, the shank including a central, longitudinal bore extending inwardly from a distal end of the shank, a slot extending longitudinally from the distal end, and a peripheral groove adjacent the distal end;
a biasing spring disposed in the bore;
a spindle disposed in the bore against the biasing force of the spring, the spindle having a width dimension, first and second square portions, and an undercut portion intermediate the first and second square portions, the undercut portion cooperating with the first and second square portions to form first and second stop surfaces;
a spring retainer having an annular portion sized to receive the shank, an arm extending outwardly from the annular portion to engage the first boss, and a pair of opposed lugs extending inwardly toward each other from the annular portion, the lugs extending through the slot to a position between the first and second stop surfaces, the ends of the lugs being separated by a distance slightly greater than the width dimension of the spindle;
a torsion spring having a first end disposed in the slot and a second end positioned to engage the second boss; and
a retaining ring disposed in the peripheral groove.

2. A door knob or lever assembly comprising:
an escutcheon having an aperture, an inner surface and at least one boss extending from the inner surface;
a knob or lever having a shank extending through the aperture, the shank including a central, longitudinal bore extending inwardly from a distal end of the shank, a slot extending longitudinally from the distal end, and a peripheral groove adjacent the distal end;
a spindle disposed in the bore, the spindle having a width dimension, first and second square portions, and an undercut portion intermediate the first and second square portions, the undercut portion cooperating with the first and second square portions to form first and second stop surfaces;
a spring retainer having an annular portion sized to receive the shank, an arm extending outwardly from the annular portion to engage the at least one boss, and at least one lug extending inwardly from the annular portion into the slot to a position between the first and second stop surfaces.

3. A spring retainer for use with a spindle, the retainer comprising:
an annular portion;
an arm extending outwardly from the annular portion; and
a pair of diametrically opposed lugs extending radially inwardly from the annular portion, the ends of the lugs being separated by a predetermined distance.

4. A spring retainer for use with a spindle, the retainer comprising:
an annular portion;
an arm extending outwardly from the annular portion; and
at least one lug extending radially inwardly from the annular portion.

5. A method of installing a spring retainer in a door knob shank comprising the steps of:
providing a shank having a central, longitudinal bore, a slot, and a peripheral groove;
positioning a biasing spring in the bore;
providing a spindle having a width dimension, first and second square portions, and an intermediate portion disposed between the first and second square portions and defining first and second stop surfaces;
providing a spring retainer having an annular portion sized to receive the shank, an arm extending outwardly from the annular portion, and a pair of opposed lugs extending inwardly from the annular portion;
positioning the lugs between the first and second stop surfaces;
inserting the spindle into the bore with the lugs extending through the slot; and
positioning a retaining ring in the peripheral groove.
